(19) United States
(12) Patent Application Publication
(10) Pub. No.: US 2017/0067455 A1
(43) Pub. Date: Mar. 9, 2017

(54) LINEAR ACTUATOR

(71) Applicant: Techni Waterjet Pty Ltd, Campbellfield, Victoria (AU)

(72) Inventors: Darren J. Reukers, Campbellfield, Victoria (AU); Jose Munoz, Brighton, MI (US)

(21) Appl. No.: 15/121,344

(22) PCT Filed: Feb. 25, 2015
(86) PCT No.: PCT/AU2015/000105

§ 371 Date: Aug. 24, 2016

(30) Foreign Application Priority Data
Feb. 26, 2014 (AU) 2014900631

(51) Int. Cl. F04B 9/04; F04B 19/22; F04B 53/08; B24C 5/00; F04B 53/16; F04B 53/18; F16H 57/04; F16H 25/22; F04B 17/03; F04B 53/14

(52) U.S. Cl. CPC F04B 9/045; F04B 17/03; F04B 19/22; F04B 53/08; F04B 53/14; F04B 53/16; F04B 53/18; F16H 57/0497; F16H 25/2204; B24C 5/00; F16H 2025/2078

(57) ABSTRACT

A linear actuator comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism, the drive mechanism having opposed ends, one end coupled to a piston arranged within a cylinder to define a pumping chamber between the piston and the cylinder, wherein alternating rotation of the rotor shaft causes reciprocal linear displacement of the piston within the pumping chamber, and the linear displacement of the drive mechanism operates a lubrication system within the linear actuator.

### TECHNICAL FIELD

This invention relates to a linear actuator. One form of the linear actuator is an ultra-high pressure pump particularly for use in waterjet cutting apparatus.

### BACKGROUND OF THE INVENTION

Waterjet cutting apparatus have been used for some years to cut a variety of materials such as steel, aluminium, glass, marble, plastics, rubber, cork and wood. The work piece is placed over a shallow tank of water and a cutting head expelling a cutting jet is accurately displaced across the work piece to complete the desired cut. The cutting action is carried out by the combination of a very high pressure jet (up to 90,000 psi) of water entrained with fine particles of abrasive material, usually sand or garnet, that causes the cutting action. The water and abrasive that exit the cutting head are collected beneath the work piece in the tank.

It is in the industry associated with waterjet cutting that the expression “ultra-high pressure” (UHP) waterjets are used to define a process where water is pressurised above 50,000 psi and then used as a cutting tool. The high pressure water is forced through a very small hole which is typically between 0.1 mm and 0.5 mm in diameter in a jewel which is often ruby, sapphire or diamond.

Although pressures greater than 50,000 psi are defined as ultra-high pressure it is envisaged that these pressures could be as great as 100,000 psi and in some circumstances as high as 150,000 psi.

The issues of compactness and efficiency are significant to pumps of this nature and there is a need for pumps to operate reliably at ultra-high pressures. For existing systems, pumps need to be designed in a manner that they can be readily fitted to many types of existing waterjet cutting machines.

It is these issues that have brought about the present invention.

### SUMMARY OF THE INVENTION

According to one aspect of the invention, there is provided a linear actuator comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism, the drive mechanism having opposed ends, one end coupled to a piston arranged within a cylinder to define a pumping chamber between the piston and the cylinder, wherein alternating rotation of the rotor shaft causes reciprocal linear displacement of the piston within the pumping chamber, and the linear displacement of the drive mechanism operates a lubrication system within the linear actuator.

The linear actuator preferably comprises a hollow rotor shaft. The interior of the hollow rotor shaft may be co-axially coupled to the drive mechanism.

The linear motion of the piston within the pumping chamber may constitute a pump to thereby drive the lubrication system within the linear actuator.

The linear actuator may further comprise a check valve operably associated with an aperture within the pumping chamber, wherein the check valve moves between an open and a closed position in response to pressure changes within the pumping chamber.

The linear actuator may further comprise a plurality of apertures circumferentially disposed around the pumping chamber, the plurality of apertures each being operably associated with the check valve.

The check valve may be an O-ring, circumferentially disposed around the pumping chamber.

A second check valve may be operably associated with a second aperture within the pumping chamber, wherein the second check valve moves between an open and a closed position in response to pressure changes within the pumping chamber, in opposition to the movement of the first check valve.

The linear actuator may comprises a linearly fixed nut that is in direct engagement with the rotor shaft, the nut threadedly engaging a screw whereby axial rotation of the rotor shaft, and therefore the nut, imparts linear motion to the screw.

A first end of the screw may be adapted to receive a first piston, and a second end of the screw is adapted to receive a second piston, such that the linear motion of the screw is translated to the pistons.

The first end of the screw may be configured to prevent rotational movement of the screw within the pumping chamber.

In another embodiment, the screw is provided with an anti-rotational feature to constrain the screw to move in a linear motion only.

A head piece may be detachably secured to the first end of the screw to receive the first piston.

The head piece may comprise a cam that translates along co-operating structure of the pumping chamber, to prevent rotation of the screw.

The head piece may have a cam or bearing surface or device to prevent rotation of the screw that protrudes from the head piece and is configured to seat within the recessed slot of the drive casing thereby constraining the screw to move linearly.

The co-operating structure of the pumping chamber may be an elongate slot. The pumping chamber may have at least one recessed slot that extends axially along an outer surface of the pumping chamber.

A second head piece may be detachably secured to the second end of the screw to receive the second piston.

In another embodiment, the head piece may have a second cam disposed on an opposing side of the head piece to the first cam, the first cam and second cam being configured to engage with a pair of corresponding recessed slots within the pumping chamber. The or each cam may have an engagement surface configured to engage with the or each recessed slot of the pumping chamber, said engagement surface having a plurality of bearings thereon.

The screw may be supported within the hollow rotor shaft on a pair of end bearings. In some embodiments the end bearings may be taper roller bearings, or thrust bearings or angular contact bearings. In some embodiments the end bearings may be taper roller thrust bearings. The pair of end bearings may be seated on a first and a second journal of the rotor shaft.

In another embodiment, the lubrication system may comprise a lubricant reservoir in fluid connection with at least one lubricant conduit configured to draw lubricant into the pumping chamber, and a pair of check valves disposed at an inlet and an outlet of the at least one lubricant conduit wherein the check valves are configured to control the flow of lubricant through the at least one lubricant conduit. The pair of check valves may be configured to open and close in response to a pressure variation within the pumping chamber caused by the reciprocation of the screw.

In some embodiments, a first check valve of the pair of check valves may be urged to open when the pumping chamber is subjected to negative internal pressure. A second check valve of the pair of check valves may be urged to close when the pumping chamber is subjected to negative internal pressure.

In another embodiment, the pair of check valves may comprise a pair of O-rings disposed at opposing ends of the at least one lubricant conduit, such that movement of the pair of O-rings urges lubricant through the lubricant conduit by obstructing or opening the opposing ends of the lubricant conduit in turn. A plurality of apertures may extend through the pumping chamber and a first O-ring of the pair of O-rings may be seated such as to obstruct the plurality of apertures on an internal surface of the pumping chamber.

In another embodiment, a plurality of lubricant conduits may be disposed within an end of the pump and a second O-ring of the pair of O-rings may be circumferentially disposed contiguously with an opening of each of the plurality of lubricant conduits on the end cap.

In another aspect of the invention, there is provided a linear actuator comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism, the drive mechanism having opposed ends, one end coupled to a piston arranged within a cylinder to define a pumping chamber between the piston and the cylinder and a resilient member disposed at least partially around the piston to guide the travel of the piston within the cylinder, wherein alternating rotation of the rotor shaft causes reciprocal linear displacement of the piston within the pumping chamber.

In another embodiment, the resilient member may surround the piston to guide the travel of the piston within the pumping chamber. The resilient member may be axially constrained within the actuator. The resilient member may be encased within the housing of the actuator and thereby restrained. The resilient member may be encased within a housing of the linear actuator. The resilient member may be radially constrained by the housing. The linear actuator may further comprise a second resilient member disposed at least partially around the second piston.

According to a further aspect of the present invention there is provided an ultra-high pressure pump comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism, the drive mechanism having opposed ends, one end coupled to a piston arranged within a cylinder to define a pumping chamber between the piston and the cylinder, the pumping chamber being in fluid connection with a compression chamber, wherein alternating rotation of the rotor shaft causes reciprocal linear displacement of the piston within the pumping chamber to pressurise fluid in the compression chamber, and said linear displacement of the drive mechanism operates a lubrication system within the pump.

In some embodiments, a seal may surround the piston to prevent pressurised fluid from the compression chamber entering the pumping chamber. A lubricant of the lubricating system may be a lubricant. The lubricant may be oil.

According to another aspect of the invention, there is provided a linear actuator comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism the drive mechanism being linearly constrained within the linear actuator, and the drive mechanism having opposed ends, one end coupled to a piston arranged within a cylinder to define a pumping chamber between the piston and the cylinder, wherein alternating rotation of the rotor shaft causes reciprocal linear displacement of the piston within the pumping chamber.

In some embodiments, the drive mechanism is directly constrained to prevent rotation. Alternatively, in some embodiments the drive mechanism is indirectly constrained to prevent rotation.

In some embodiments, the drive mechanism is coupled to a linear bearing. The linear bearing may comprise a stationary base and a cooperating carriage wherein the carriage is linearly translatable along the base.

In some embodiments, the drive mechanism may further comprise a projection that translates along co-operating structure of the pumping chamber, to prevent rotation of the drive mechanism. The projection may be a cam follower. The surface of the cam follower may be provided with bearings to reduce friction during translation.

In some embodiments, the motor includes an encoder to monitor the position and/or velocity of the motor.

### BRIEF DESCRIPTION OF THE DRAWINGS

An embodiment of the present invention will now be described by way of example only with reference to the accompanying drawings in which:

FIG. 1 is a top view of an ultra-high pressure pump according to one embodiment of the invention;

FIG. 1A is a cross-sectional view of the ultra-high pressure pump of FIG. 1, taken along the section A-A, illustrating the pump at full stroke to the left;

FIG. 1B is a similar view of the ultra-high pressure pump as FIG. 1A, but illustrating the pump at full stroke to the right;

FIG. 1C is a cross-sectional view of the ultra-high pressure pump of FIG. 1, the section A-A being rotated through 45 degrees;

FIG. 2 is a magnified cross-sectional view of a first end of the pump of FIG. 1, taken along the section A-A;

FIG. 2A is a perspective view of a first end of the pump of FIG. 1, illustrating the pump at full stroke to the left;

FIG. 2B is a perspective view of a first end of the pump of FIG. 1, illustrating the pump at full stroke to the right;

FIG. 3 is a magnified cross-sectional view of the first end of the pump of FIG. 1, taken along the section A-A rotated through 45 degrees;

FIG. 4 is a perspective view of a ball screw and drive casing assembly from the pump of FIG. 1;

FIG. 4A is a perspective view of the ball screw of FIG. 4;

FIG. 4B is a perspective view of the drive casing of FIG. 4;

FIG. 5 is an enlarged view of the circular insert of FIG. 2 illustrating on an O-ring that seals a drive casing;

FIG. 5A is a cross-sectional view of the drive casing of FIG. 5, taken along the section B-B;

FIG. 6 is an enlarged view of the circular insert from FIG. 3 illustrating a pair of O-ring seals within the end housing of the pump;

FIG. 6A is a cross-sectional view through the section C-C in FIG. 3 illustrating a plurality of lubricant conduits that run through the end housing;

FIG. 7 shows a lubricant flow path into and out of the pump via a heat exchanger;

FIG. 8 is a cross-sectional view of an ultra-high pressure pump according to one embodiment of the invention, taken along the section A-A of FIG. 1, illustrating the pump at full stroke to the left;

FIG. 8A is an enlarged view of a first end of the pump of FIG. 8, illustrating four sets of bearings supporting the rotor; and

FIG. 8B is an enlarged view of a second end of the pump of FIG. 8, illustrating a second drive casing and second pumping assembly about the second piston.

### DETAILED DESCRIPTION

An embodiment of the invention provides a linear actuator having a motor adapted to axially rotate a hollow rotor shaft in alternating directions. The motor has a stator positioned co-axially around the hollow rotor shaft with the interior of the rotor shaft being co-axially coupled to a drive mechanism to convert axial rotation of the rotor shaft into reciprocal displacement of the drive mechanism. The drive mechanism has opposed ends, where one end is coupled to a piston and arranged within a cylinder to define a pumping chamber between the piston and the cylinder. The alternating rotation of the rotor shaft causes reciprocal linear displacement of the piston within the pumping chamber, and the linear displacement of the drive mechanism operates a lubrication system within the linear actuator.

One embodiment of the invention described in detail and illustrated herein relates to an ultra-high pressure pump 10 especially for use in waterjet cutting machinery. However, it should be understood that the invention of the subject application is, in essence, a fluid drive mechanism which can be used in a wide variety of scenarios where close careful control of the drive is necessary. Thus one of the uses of the drive mechanism is a linear actuator that can be used to replace hydraulic cylinders, which are inherently inefficient, noisy, dirty, and not precise, in a wide variety of engineering applications such as presses, robotics, materials handling and other similar uses.

Ultra-high pressure pumps can generate pressures of anywhere from 10,000 psi to 150,000 psi. Waterjet cutting machines will require pressures equal to and in excess of 50,000 psi, however, industrial cleaners and machines for homogenising and pasteurising will operate on pressures of between 10,000 psi to 30,000 psi. These pressures are far in excess of home devices and cleaning equipment, which would generally be limited to around 3,000 psi as pressures in excess of 3,000 psi are capable of causing injury to untrained users.

Due to the nature of the machines and downstream tools to which ultra-high pressure pumps are required to be connected to, there is a constant drive to provide lighter, more compact and more efficient pumps. A more compact design provides the opportunity for different mounting types and locations and furthermore, provides the inherent savings in mass and material cost that drive the manufacturing costs of a product.

Throughout this specification references are made to a preferred embodiment of the invention using water as a high pressure fluid. However, it is contemplated that alternative fluids may be pressurised using the pump, and the disclosure herein is not intended to be limited to water.

When the fluid drive mechanism is a pump 10 it comprises a motor that drives two reciprocating pistons 50, 51 that project from either end of the pump 10 to operate within compressions chambers. The compression chambers are illustrated in the accompanying Figures as cylinders 55, 56 in which the water introduced into the cylinders 55, 56 is pressurised to pressures of greater than 50,000 psi. The pressurised water is then forced out of the cylinders 55, 56 through respective high pressure conduits 58, 59 at each end of the pump 10. The reciprocating pistons of the pump further operate a lubricating function through the pump. It is the use of a motor with a closed feedback loop that provides the opportunity to closely and carefully control the drive within the pump 10. The motor used may be in various different forms albeit a stepper motor or a servo motor or the like.

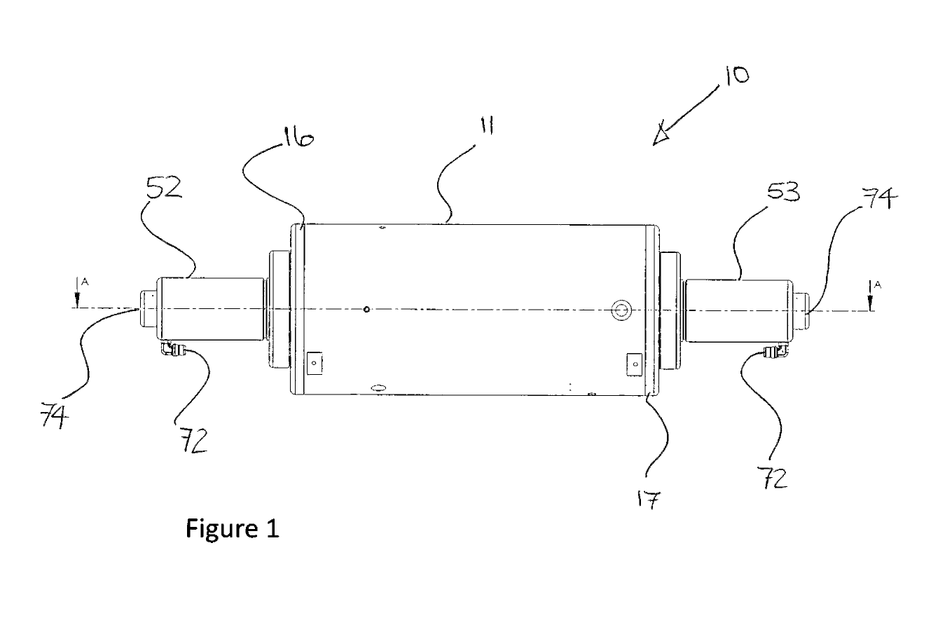

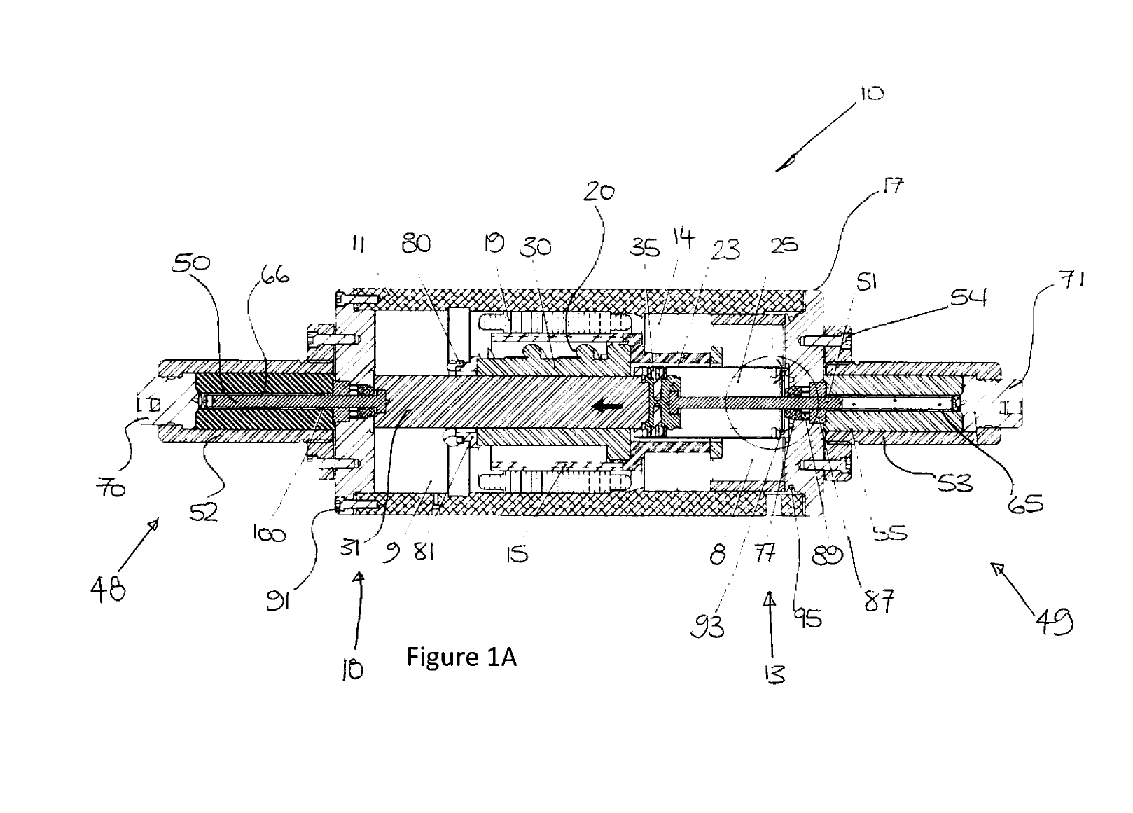

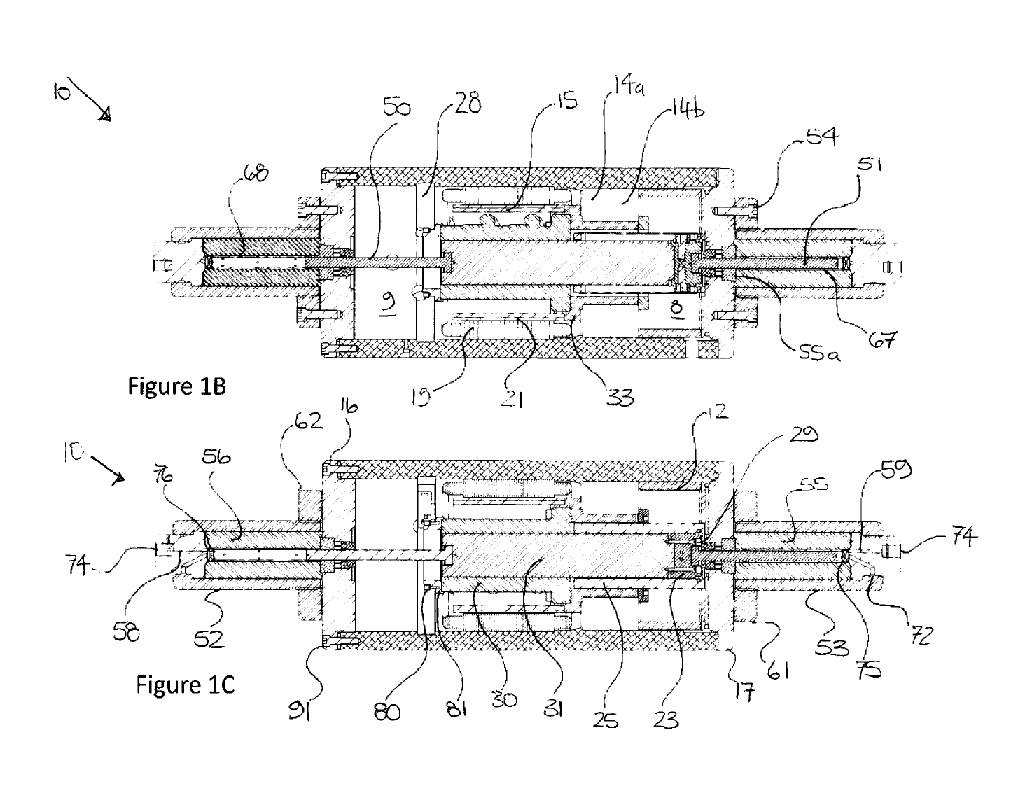

As shown in FIG. 1, an ultra-high pressure pump 10 has a cylindrical housing 11 and two externally symmetrical end caps 16, 17. Within the housing 11 disposed between the end caps 16, 17 is a hollow rotor shaft 15 and associated magnets 21 that is supported about the windings 19 of a servo motor.

FIG. 1A illustrates a cross-section through the pump 10 taken along section line A-A with the pump at a maximum stroke position to the left. FIG. 1B is a cross-sectional view of the pump 10 taken axially along section line A-A with the pump at maximum stroke to the right, and FIG. 1C is a cross-section in the same orientation as that shown in FIG. 1B but rotated through 45 degrees.

Referring now to FIGS. 1A, 1B and 1C in combination, a first end 13 of the rotor shaft 15 is illustrated being supported by annular bearings 14A, 14B located between the housing 11 and the rotor shaft 15.

The end 18 supports an encoder 80 housed adjacent to a reader head bracket 28. The encoder 80 monitors the rotary position of the rotor shaft 15 when the pump 10 is in use and uses this information to calculate the velocity, acceleration and linear position of the pistons 50, 51.

The encoder 80 is attached to the ball screw nut 30 via an adaptor, shown in FIG. 1A as an aluminium disc 81. The encoder 80 measures the position of the rotor 15 by monitoring a magnetic sine wave given off by the rotor 15 as it rotates. Alternative means of controlling and monitoring the rotor 15 are contemplated, such as directly controlling the linear displacement of the ball screw 31 or employing proximity sensors to sense the ball screw 31 location.

The rotor shaft 15 houses a ball screw nut 30 which is in turn threadedly engaged onto an elongated ball screw 31. The ball screw nut 30 is linearly constrained within the pump housing 11 and the ball screw 31 is disposed such as to extend between the end caps 16, 17. Although the pistons 50, 51 extend through the end caps 16, 17, the ball screw 31 does not. However, it is contemplated that the ball screw 31 could be extended to reduce the length of pistons 50, 51 in some embodiments, although higher sealing tolerances would then be required to prevent the release of the highly pressurised fluids in the cylinders 55, 56 back into the pumping chamber (illustrated in the Figures as drive casing 25).

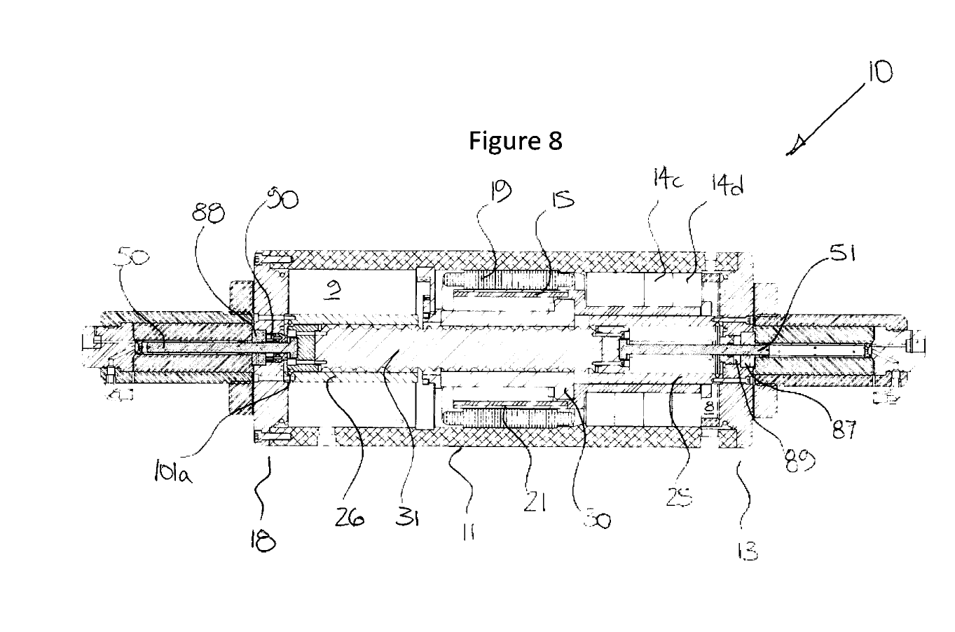

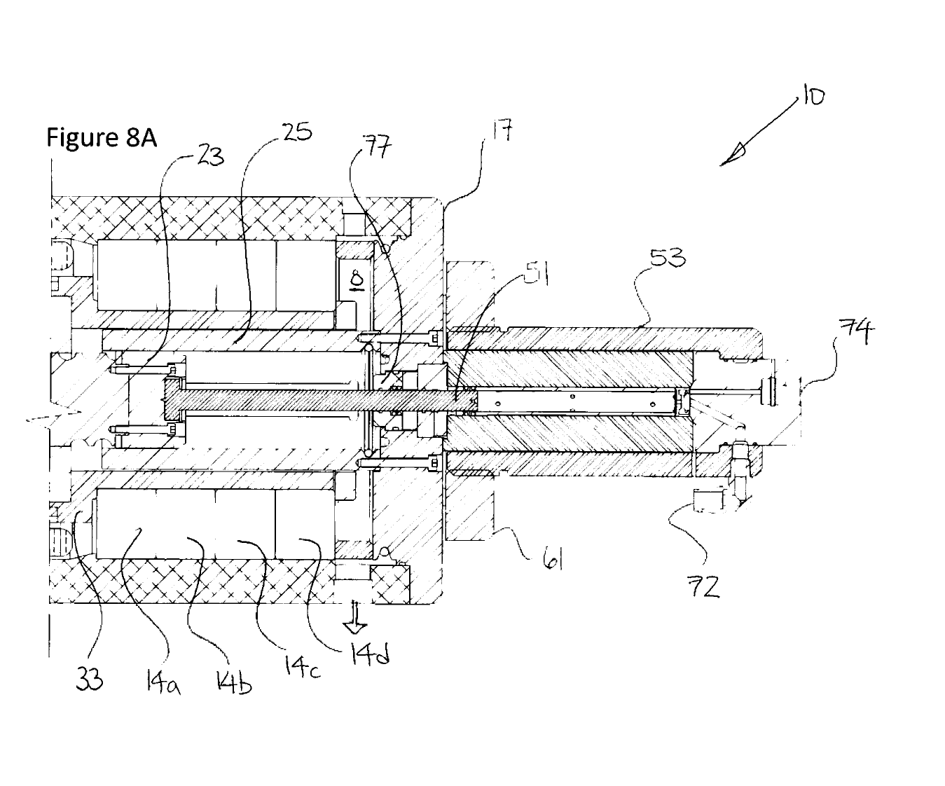

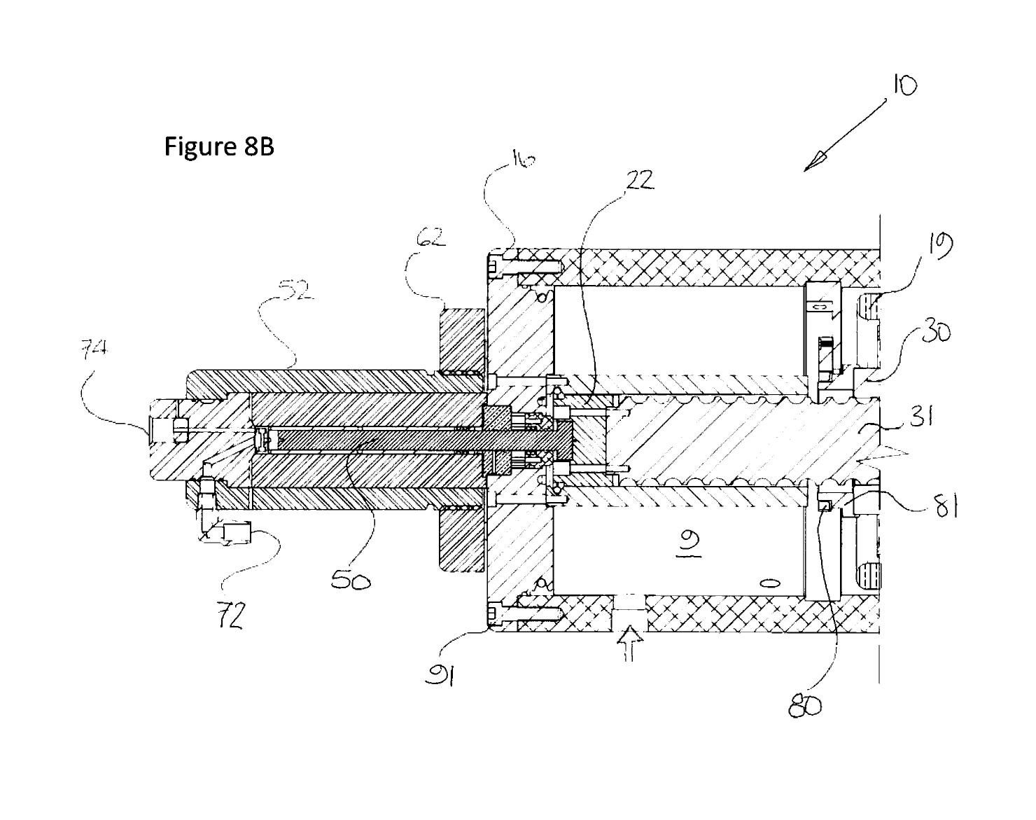

In FIGS. 1B and 1C the ball screw nut 30 is disposed directly adjacent to a rotor bearing journal 33 upon which the bearings 14a and 14b sit. Additional bearings 14c and 14d are contemplated to surround and support the drive casing 25, in some embodiments, as illustrated in FIG. 8 and FIG. 8A). The ball screw nut 30 can also be disposed at the second end 18 of the rotor 15; however, this places thrust loads from the ball screw 31 on the rotor 15, which in turn necessitates a stronger rotor 15 thereby incurring additional mass and cost.

Positioning the ball screw nut 30 next to the bearings 14a, 14b leaves only the radial loads from the magnets to be borne by the rotor 15 and can almost half the inertia loads upon the rotor 15. This is important in the pump 10 as the reciprocating motion of the ball screw 31 causes it to rotate at around 1200 rpm. Each stroke of the ball screw 31 involves a rapid acceleration of the ball screw 31, a sudden stop and a rapid acceleration in the opposite direction. Due to the sudden stop and rapid change in direction, the inertia properties of the rotor 15 have a large impact on the workings of the pump 10, influencing the kinetic energy within the moving parts, the wear on the pump and the likelihood of pump failure.

The ball screw nut 30 is in direct engagement with the of the rotor shaft 15 and is constrained against linear movement by physical abutment with the rotor bearing journal 33 such that the ball screw nut 30 can only rotate with the rotor shaft 15.

The rotor 15 and the rotor bearing journal 33 can be formed integrally e.g. cast and machined to tolerance. However, in the FIGS. 1A-1C the journal 33 can be seen as a separate component connected to the rotor 15 which provides advantages to producing the rotor 15 and significant cost savings.

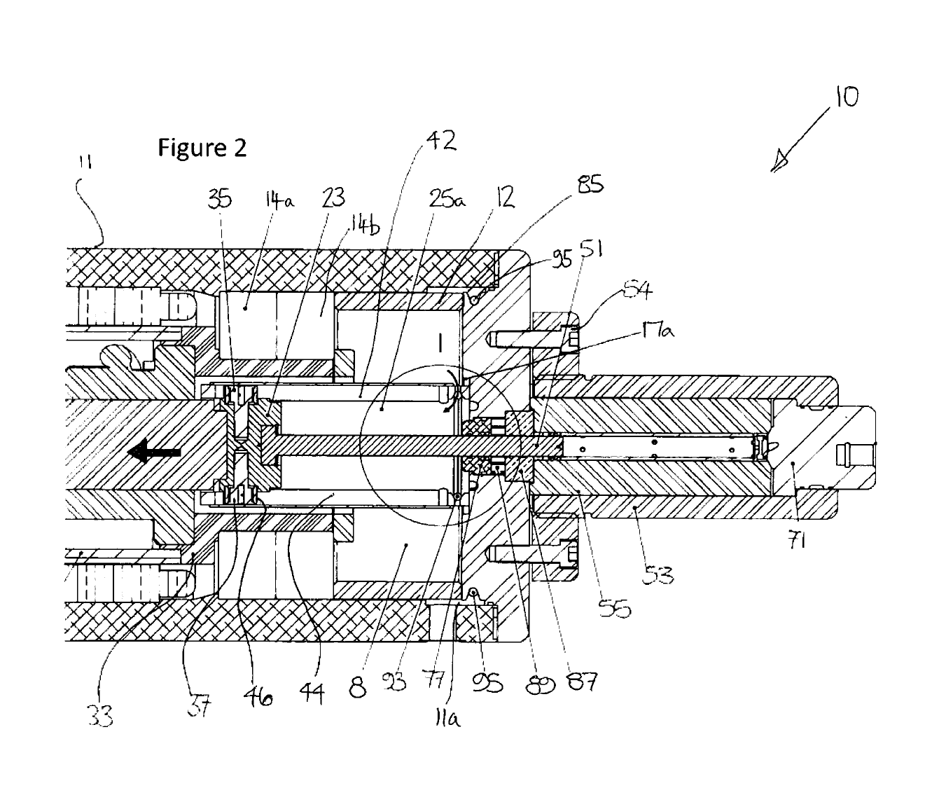

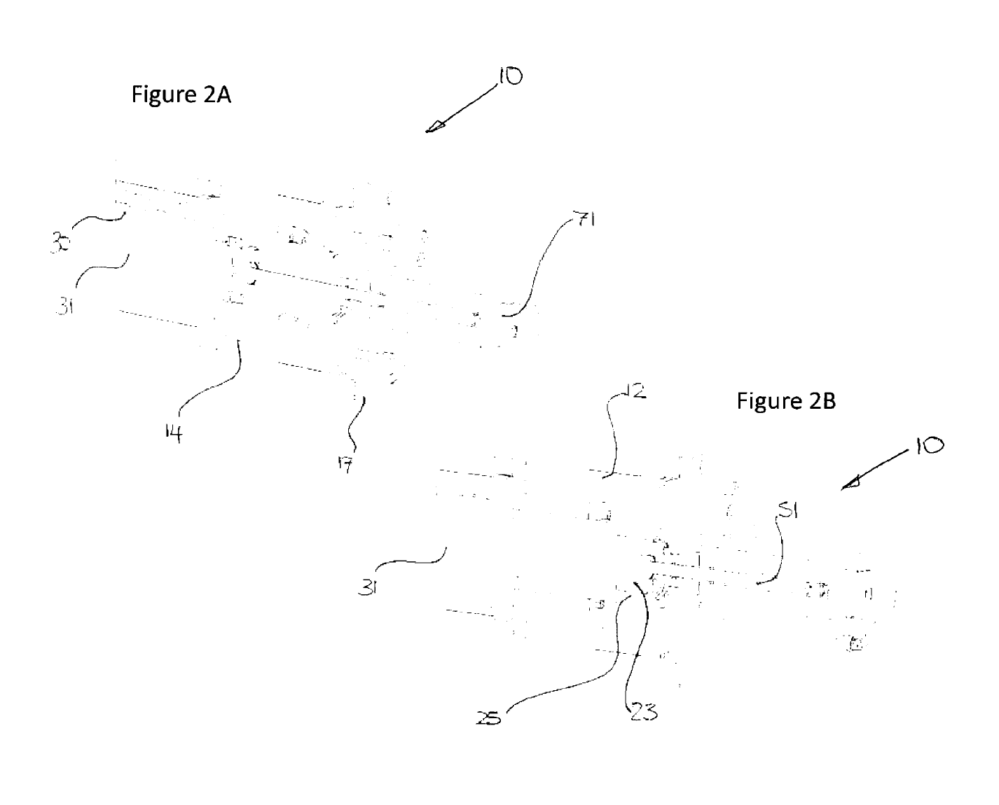

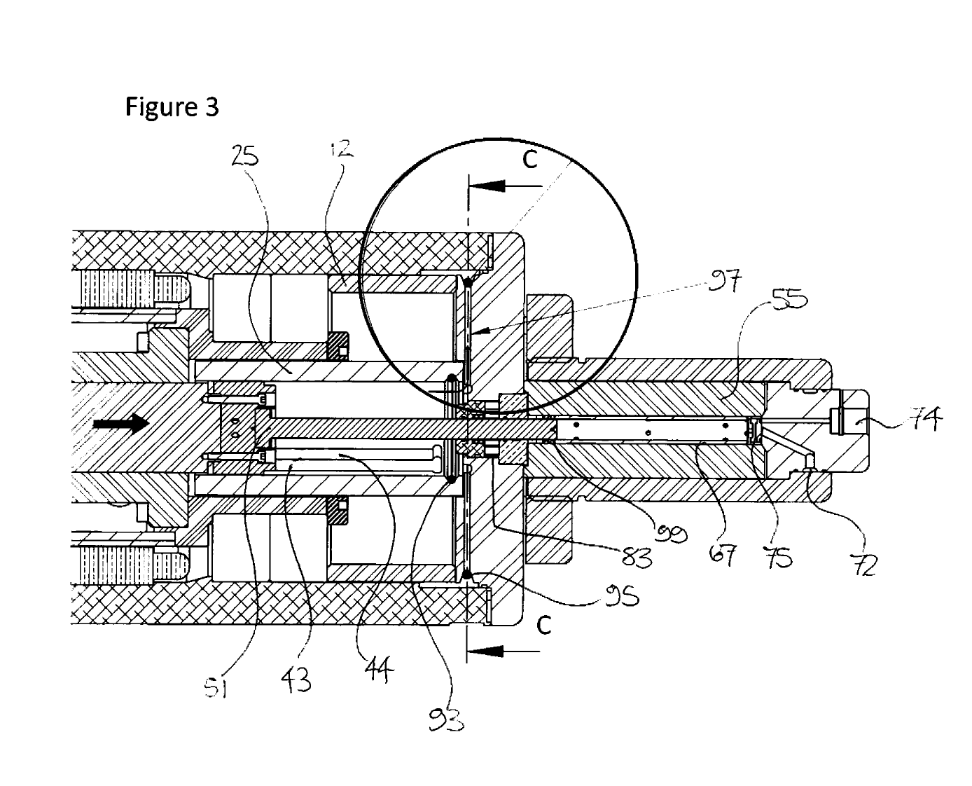

The screw 31 has a threaded exterior 20 with a head piece 23 attached at a first end of the screw 31. The head piece 23 is rigidly affixed to the first end 13 of the ball screw 31 and translates along the drive casing 25 in a linear reciprocating motion only (rotational motion is constrained). The drive casing 25 extends from the end cap 17, and is co-axially aligned within the pump housing 11. The drive casing 25 is open at both ends to receive and guide the ball screw 31 and attached head piece 23 linearly within the housing 11. The end cap 17 of the housing 11 is preferably configured to receive a distal end of the drive casing 25 into a recess 17a on its inner face as shown in more detail in FIGS. 2 and 3.

The head piece 23 is rigidly connected to the first end of the ball screw 31 and is preferably removable and thus replaceable. This provides for ease of manufacture, routine maintenance and replacement. The end piece 23 is affixed to the ball screw 31 with a series of bolts 29. The weight distribution of the bolts around the head piece 23 is preferably evenly balanced. It is contemplated that various standard screws or bolts could be employed provided that the head piece 23 and ball screw 31 are secured under working load conditions, for example hex head or cap head bolts would provide an equally acceptable connector. It is further contemplated that the head piece 23 could be machined from the ball screw 31 without any loss of function to the pump 10.

The head piece 23 and ball screw 31 are subject to high loads during use of the pump 10 and it is important that the head piece 23 and screw 31 do not move relative to one another due to the high pressures and velocity at which these components travel during use of the pump 10. The cross-sectional configuration shown in FIG. 2 illustrates a 6-bolt mounting; however, fewer or more bolts 29 can be added to the mounting depending on the size and loads on the pump 10. Should this connection fail within the pump 10 during ultra-high pressure use, a catastrophic failure could ensue potentially causing significant damage to the pump 10.

The head piece 23 (shown in FIG. 2) is substantially cylindrical to facilitate travel smoothly up and down the drive casing 25 in a linear motion. A first cam follower 35 is shown in cross-section threadingly attached to a top portion of the head piece 23. In a similar manner a second cam follower 37 is shown in cross-section threadingly attached to a bottom portion of the head piece 23.

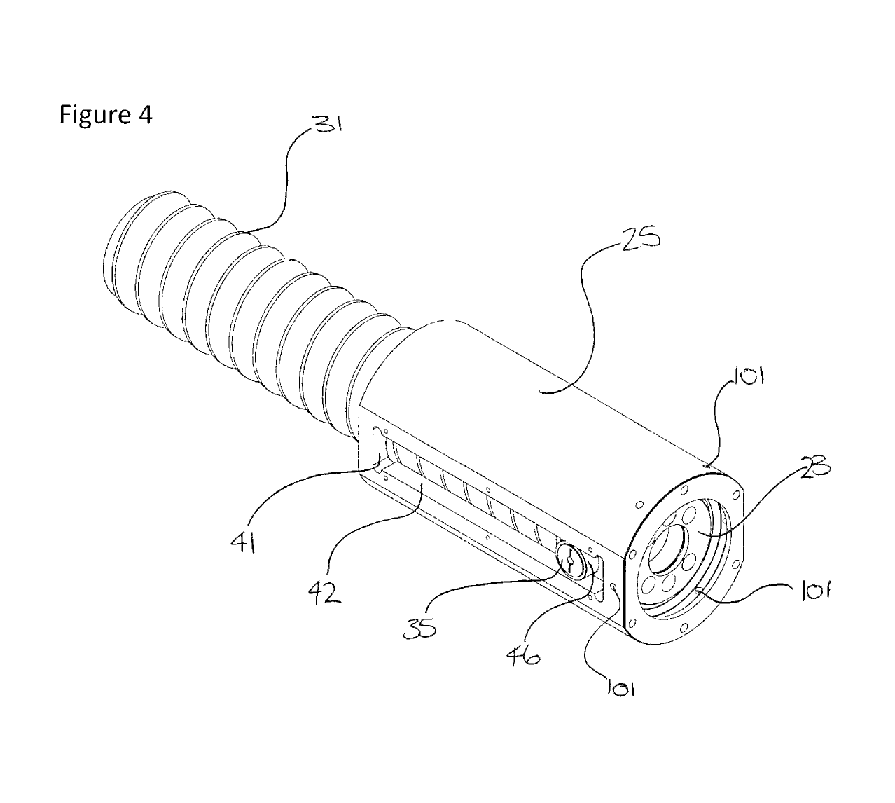

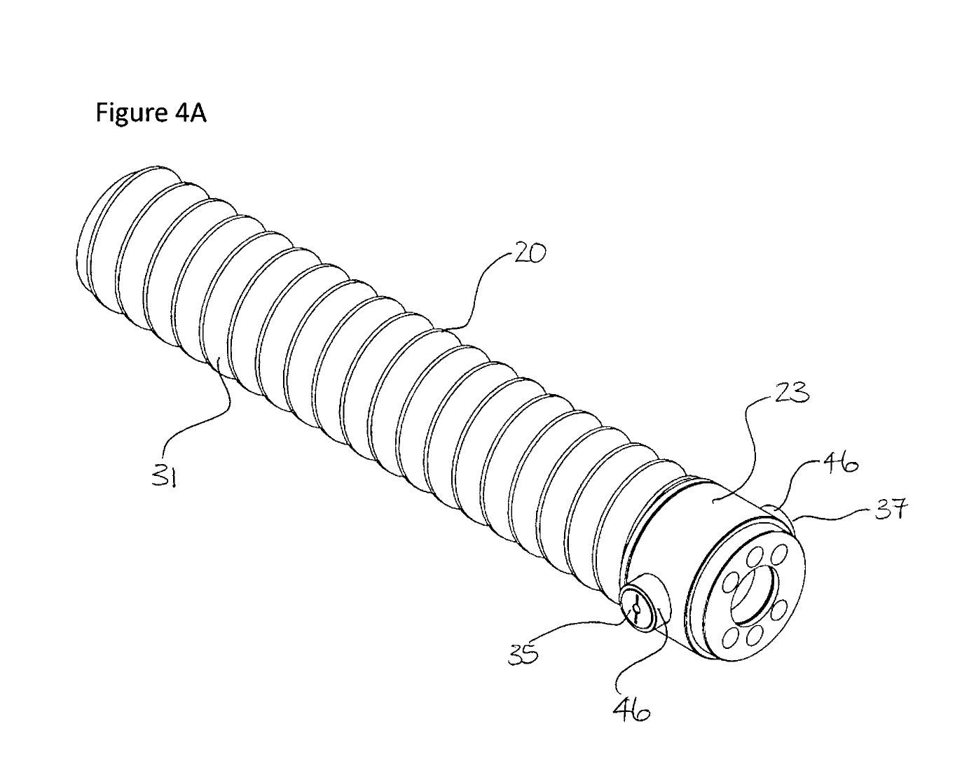

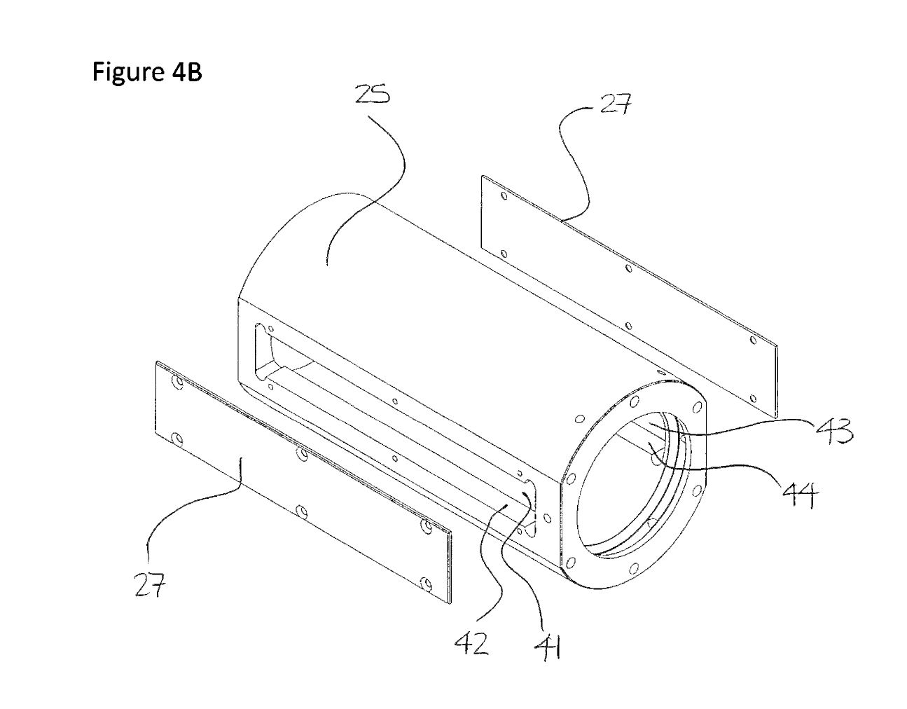

Each cam follower 35, 37 comprises a cylindrical, threaded shaft for attachment to the head piece 23 and a cylindrical head having a circumference approximately twice that of their threaded shafts. The external circumference of the cylindrical head is surrounded by needle roller bearings 46, to allow the cam followers 35, 37 to smoothly and repeatedly travel coaxially in contact with the drive casing 25 as shown in more detail in FIGS. 4 and 4B.

The cam profile is provided by a pair of slotted recesses within the drive casing 25: an upper slot 41 and a lower slot 43 (shown in detail in FIGS. 4 and 4A. The slots 41, 43 extend axially along the length of the drive casing 25 and stop shy of the ends of the chamber 25. The slots 41, 43 are disposed opposite one another for balance although they could be unevenly spaced without affecting the workings of the pump 10. It is further contemplated that additional slots could be employed to retain the ball screw 31 motion in a linear direction, if required. The slots 41, 43 extend through the walls of drive casing 25 and thereby create a cam profile or guide in which the upper 35 and lower cam follower 37 will seat and travel.

The axial walls 42, 44 of the upper slot 41 and lower slot 43, respectively, are machined to a high tolerance to provide a bearing surface for the needle roller bearings 46 to run against. This reduces wear on the interfacing components that will be bearing against each other under high temperatures and pressures, repeatedly.

As the cam followers 35, 37 are guided by the recessed slots 41, 43 of drive casing 25, the head piece 23 and thereby the ball screw 31 is constrained to travel linearly along the drive casing 25, to avoid any rotation of the ball screw, and the head piece 23 displaces the pistons 50, 51 in a purely longitudinal direction. The cam followers 35, 37 being surrounded by needle roller bearings (46) to run along the recessed slots 41, 43, are shown in FIG. 4 in assembled form and in FIGS. 4A and 4B in a disassembled form.

The ball screw 31 can be constrained to linear motion by means other than needle roller bearings or cam followers, for example a linear bearing or dovetail slides, having a linear stationary base and a moving carriage along the length of the bearing. However, when compared to the needle roller bearings 46 on the cam followers 35, 57 a typical linear bearing set-up would be considerably more bulky. The size and configuration of a moving carriage bearing system would demand significantly more packaging space within the pump housing 11, which in turn would increase the weight of the pump 10 and consequentially, increase material costs.

The first end 13 of the rotor shaft 15 is supported by annular bearings 14a, 14b which are packaged in contact with the interior of the pump housing 11. The rotor 15 is supported at both ends. The bearings 14a, 14b sit on the rotor bearing journal 33 to support the first end of the shaft 15. A second bearing journal at the second end of the rotor is provided by way of an encoder adaptor 81. The encoder adaptor 81 is supported by an annular bearing 28.

The heat generated within the bearings 14 is reduced by designing the pump 10 to accommodate smaller diameter bearings 14. A smaller diameter of bearing 14 means that the ball bearings within the bearings 14 have less distance to travel and thereby generate less friction and less heat. A consequence of the bearings being smaller and lighter is that they have a lower inertia and are therefore, easier to accelerate and decelerate.

The drive casing 25 is a clearance fit and is received into the bearing journal 33. Housed within the first end of the pump housing there is also a housing lining 12, which positions and retains the annular bearings 14a, 14b in a predetermined location, relative to the end piece 17. The second end of the rotor shaft 13 is arranged differently to house an encoder 80 which is seated in an encoder adaptor 81.

In a preferred embodiment bearing 14a and bearing 14b are angular contact bearings; however, taper roller thrust bearings could also be used. These bearings are configured to handle large loads, both axially and radially, upon the rotor 13. It is contemplated that alternative forms of bearings could also be used

Returning to FIG. 1A, opposite ends of the ball screw 31 are illustrated being coupled to matching piston/cylinder pumping assemblies 48, 49. Each assembly 48, 49 comprises a cylinder housing 52, 53 enveloping a cylinder 55, 56 with a narrow internal bore 65, 66. The internal bore 65, 66 is provided with an internal cylinder liner 67, 68 in which a piston 50, 51 axially reciprocates. The pistons 50, 51 are coupled to the respective ends of the ball screw 31 and thereby configured to reciprocate. The piston 50 is mounted directly into the ball screw 31, and the piston 51 is mounted to the ball screw 31 through the head piece 23.

The piston 51 is rigidly mounted within the head piece 23 and is cyclically displaced back and forth within the drive casing 25 in a longitudinal direction constrained by the cam followers 35, 37 as described above. At full stroke the pistons 50, 51 extend substantially through the entire cylinder 55, 56 but do not exceed the depth of the cylinder liners 67, 68.

Shown in detail in FIG. 3, the piston 51 can be seen at zero stroke within the liner 67 i.e. fully displaced towards the second end of the pump 10. At the end of the cylinders 55, 56 are sealing heads 70, 71. Disposed between the cylinders 55, 56 and the sealing heads 70, 71 respectively, is a high pressure check valve 75, 76 which prevents flashback of pressurised fluid.

Each cylinder 55, 56 is supported by a cylinder housing 52, 53 that is removably attached to the respective ends 16, 17 of the pump 10 via flanges 61, 62. The flanges 61, 62 are bolted to the end caps 16, 17 of the housing 11 by a number of retaining bolts 54.

The end of each cylinder housing 51, 52 supports a valve assembly that incorporates the sealing heads 70, 71 into which a water inlet 72 flows via an internal low pressure check valve (not shown) to an outlet pipe 74 of narrow diameter. The check valve is a low pressure check valve, in contrast to the aforementioned check valve 75, 76 which is configured to be a high pressure check valve.

The sealing heads 70, 71 are precision bored therethrough to provide high pressure conduits 58, 59 at each end of the pump 10, through which the high pressure water is propelled when the pump 10 is in use. The sealing heads 70, 71 also receive and channel the water inlet 72 and the high pressure water outlet 74 therein.

Each valve assembly has the low pressure water inlet 72 controlled by the low pressure check valve communicating with the high pressure conduits 58, 59 at a 45° angle to the axis of the cylinder 55, 56. The high pressure outlet 74 is positioned co-axially to the end of the cylinder 55, 56 wherein the internal high pressure check valve 75, 76 transfers the water at high pressure to an attenuator (not shown). Essentially, the high pressure conduits 58, 59 are simply channels to take the high pressure fluid from the cylinders 55, 56 to the high pressure check valves, and then into a high pressure piping arrangement (not shown) to a cutting head or other downstream use.

To activate the linear pump 10, the servo motor is activated which causes the rotor shaft 15 to rotate which in turn rotates the ball screw nut 30, which is constrained from axial movement, meaning that the ball screw 31 moves linearly within the ball screw nut 30. By reversing the direction of rotation of the rotor shaft 15, the ball screw 31 can be caused to reciprocate back and forth to give reciprocating motion to the pistons 50, 51 to in turn pressurise the water that is introduced into the cylinders 55, 56 via the water inlets 72 to effect high pressure delivery of water from the outlets 74 at pressures greater than 50,000 psi and up to 100,000 psi. In the embodiment of pump 10 shown in the accompanying Figures, the cylinders 55, 56 are of equal volume, as are the high pressure conduits 58, 59.

In a preferred mode of running the pump 10 the high pressurised water is drawn from the respective outlets 74 at each end of pumping assemblies 48, 49 and the two high pressure outputs are fed into a single high-pressure line which is, in turn connected to a cutting head to focus and direct the high pressure water jet. This arrangement can produce a small variation in output, around 5,000 psi, as the ball screw 31 reverses direction. However, if two pumps 10 according to the invention are run in series and out of phase, this variation (or pulsing effect) can be mitigated, such that the cutting head or other downstream operations experience no pulse of fluctuation in output.

Where the cylinder 55 and the drive casing 25 meet is a high tolerance area of the pump 10. The piston 51 travels through the drive casing 25 and enters the bore 65 of cylinder 55. This interface between the chamber 25 and the cylinder bore 65 is sealed by an oil seal 77, which is intended to prevent (or at least minimise) any lubricating fluid or lubricant from leaving the drive casing 25 and entering the cylinder 55 and ultimately restricts lubricating fluid or oil from entering the high pressure compression chamber 59. The high pressure seal 77 between the inner ends of the cylinder 55, and the piston 51 also prevents back pressure. A similar high pressure sealing arrangement is located within cylinder 56 at the second end of the pump 11, although there is no drive casing at the second end of the pump 11.

The cylindrical pump housing 11 has open ends, which are sealed with the end caps 16, 17. The end caps 16, 17 are bolted to the housing 10 by a plurality of retaining bolts 91. The retaining bolts may be allen head, cap head, hex head or any suitable alternative connector that allows the end caps 16, 17 to be easily removed for maintenance and refurbishment of the pump 10.

The drive casing 25 abuts the end cap 17 centrally and is received into a central recess 17a within the end cap 17. The drive casing 25 is encircled by a housing liner 12 thereby forming a cavity between the two which provides a lubricant chamber 8 within the pump 11. Through a series of check valves, an internal lubricating system is provided for the pump, and in particular for the for the ball screw 31, cam followers 35, 37 and bearings. The internal lubricating system is run directly off the reciprocating action of the ball screw 31.

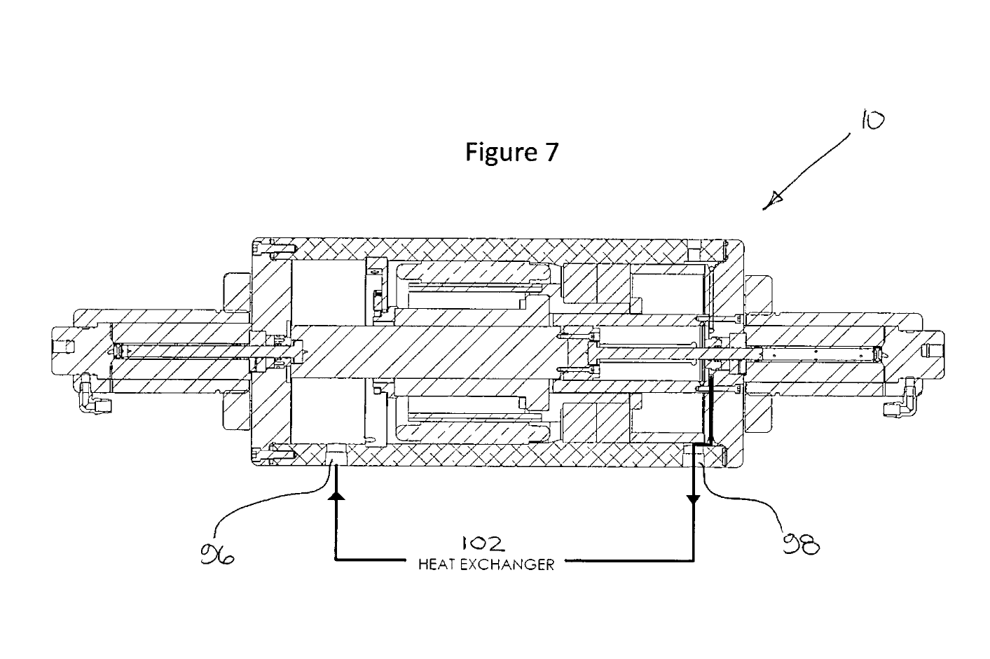

A lubricant is passed between the lubricant chamber 8 and a lubricant return chamber 9 within the pump 11 (shown in detail in FIG. 7). As the lubricant exits the pump 11 via lubricant outlet 98 it is directed through a heat exchanger 102 to reduce the temperature of the lubricant. Upon exiting the heat exchanger 102 the lubricant is directed into the lubricant return chamber 9 where the lubricant comes into contact with the ball screw 31 within the housing 11 and then travels towards the first end of the pump, thus returning to the lubricant chamber 8. FIG. 7 illustrates the flow of lubricant from the end cap 17 out of the pump through the outlet 98 into the heat exchanger 102 and back into the return chamber 9. Alternative forms of cooling device are contemplated in place of the heat exchanger. The chambers 8 and 9 in combination provide an internal lubricant reservoir for the pump 11 and these two chambers are fluidly connected to allow the lubricant to travel therebetween.

A lubricant conduit 97 is provided in the end cap 17 which is configured to channel lubricant from the drive casing 25, via the lubricant conduit 97 and out of the lubricant outlet 98. A first O-ring 93 and a second, larger O-ring 95 are disposed within the lubricant flow path on opposing sides of the lubricant conduit 97 such the first O-ring 93 controls entry of the lubricant from the chamber 8 into the drive casing 25 and the second O-ring 95 controls the lubricant release from the lubricant conduit 97 to exit the pump 10 via the lubricant outlet 98.

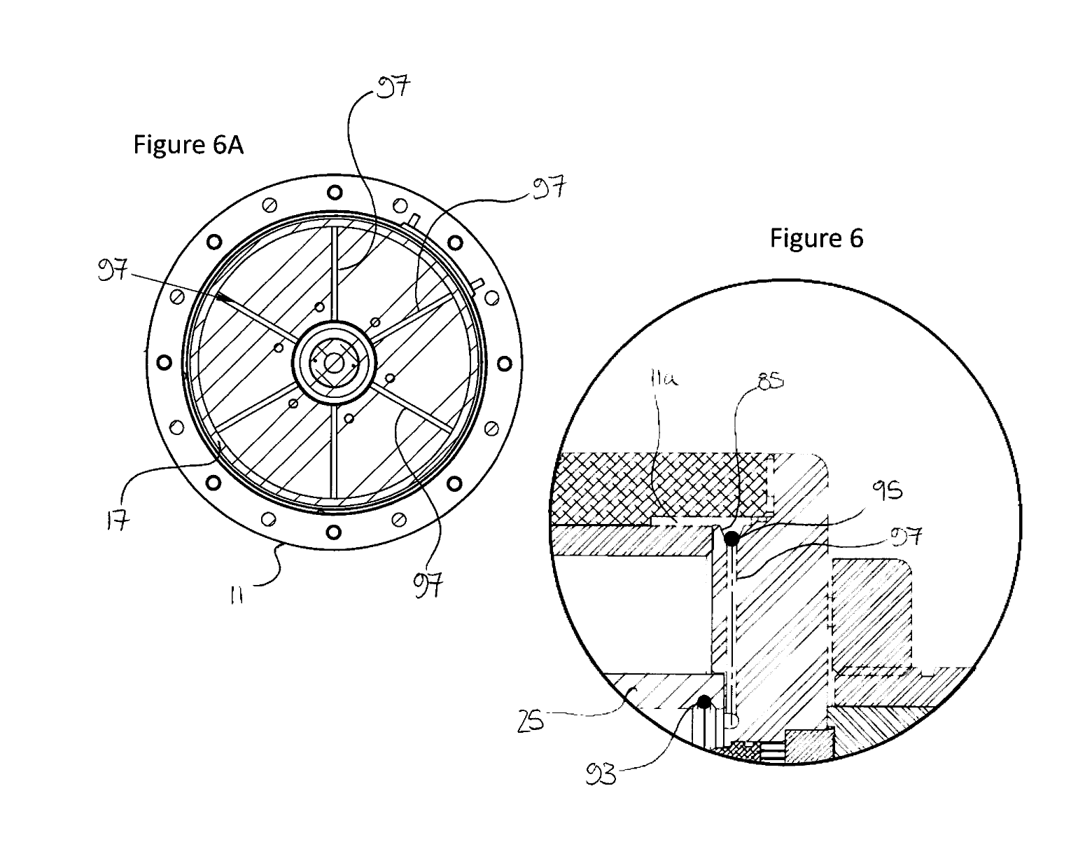

These O-rings are essentially used as check valves to control the movement of a measured dose of lubricant into and out of the drive casing 25 for each reciprocal stroke of the ball screw 31. In the preferred embodiment, illustrated in FIGS. 6 and 6A, a plurality of lubricant conduits 97 are provided to distribute lubricant evenly throughout the end cap 17.

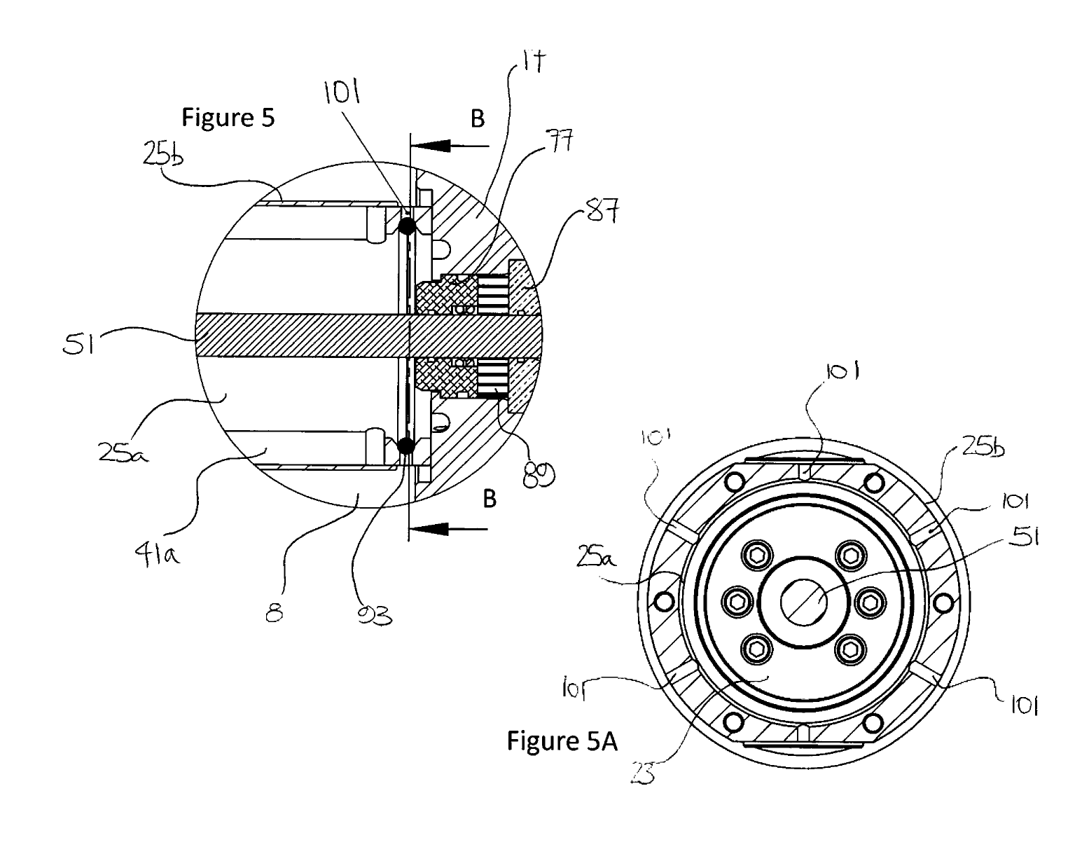

The second O-ring 95 is configured to move between an open and closed position and thereby open and close a plurality of outlets of the plurality of lubricant conduits 97. Simultaneously, the first O-ring 93 is configured to open and close a plurality of apertures 101 (show in FIG. 5) within the drive casing 25 in response to pressure variations within the drive casing 25, as the reciprocating ball screw 31 linearly translates within the drive casing 25. Although the Figures show a plurality of apertures 101 it is contemplated that a single aperture 101 would be effective to facilitate the movement of the lubricant around the system, however, more than one aperture allows for a more even dispersal of the lubricant within the chamber 25.

The end cap 17 is circular in cross-section and steps down in diameter approximately half way through its depth. This step change gives the end cap 17 a stopper-like profile and creates a circumferential wall 85 around the end cap 17. The narrow end of the end cap 17 is inserted into the open end of pump 10 to seal the pump 10 and the circumferential wall 85 is brought into sliding contact with the inner surface 11a of the housing 11. The larger outer diameter of the end cap 17 further provides a mounting flange that overlaps end-faces of the housing 11 and into which retaining bolts 54 are inserted to retain the end cap 17 on the pump housing 11, as shown in FIG. 2.

Around the inner wall 85 of the end cap 17 there is provided a circumferential groove in which the second O-ring 95 is seated. The groove has a u-shaped (or v-shaped) profile, for receiving the O-ring 95. Disposed at six equidistantly spaced locations around the circumferential groove are inlets to six identical lubricant conduits 97. The lubricant conduits 97 channel the lubricant from the drive casing 25 outwardly towards the outer wall 85 of the end cap 17 and out of the pump 10.

The first O-ring 93 is seated in a u-shaped (or v-shaped) circumferential groove disposed on an inside surface 25a of the drive casing 25. Disposed at a plurality of equidistantly spaced locations around the circumferential groove are six symmetrical apertures 101 that pass entirely through the thickness of the drive casing 25 from the inner surface 25a to the outer surface 25b. When the first O-ring 93 is drawn towards the inner wall 25a of the drive casing 25 the apertures 101 become sealed by the O-ring 93. When the O-ring 93 is drawn away from the drive casing inner surface 25a the apertures 101 are opened such that lubricant may pass/flow from the lubricant chamber 8 to the inside of the drive casing 25.

In a first movement of the pump's stroke, the ball screw 31 withdraws the piston 51 from the cylinder 55 (see the arrows in FIG. 2 which depict the directional movement of the screw 31 and the lubricant being drawn into the chamber 25). This action causes a negative pressure within the piston cylinder 25 which urges the first O-ring 93 away from the drive casing inner surface 25a opening the plurality of apertures 101 within the drive casing 25 to allow lubricant to enter from chamber 8. This retraction of the piston 51 also urges the second O-ring 95 to move towards the drive casing 25 and seat into the end cap 17, thus closing the outlets to the plurality of lubricant conduits 97.

As the first O-ring 93 opens apertures 101 and outer O-ring 95 closes the lubricant conduits 97, a measure of lubricant from the chamber 8 is released into the drive casing 25 to lubricate and cool the heated components of the drive casing 25.

In a second movement of the pump's stroke, in an opposing direction to the first movement described above, the ball screw 31 pushes the piston 51 into cylinder 55 (see the arrows in FIG. 3 which depict the directional movement of the screw 31 and the lubricant being pushed through the lubricant conduits 97 out of the chamber 25). The movement of the head piece 23 in the drive casing 25 increases the pressure within the drive casing 25 (as the volume therein is compressed) urging the first O-ring 93 to move towards the drive casing inner wall 25a and thereby closing apertures 101. Furthermore, the second O-ring 95 is pushed away from the drive casing 25 and thereby raised from the circumferential seat within the end cap 17 opening the lubricant conduits 97 and releasing a measure of used (heated) lubricant to be channeled back to the heat exchanger 102.

The first 93 and second O-rings 95 are circular in configuration and also generally circular in cross-section. The cross-section of the O-rings may be altered to provide a better fit and tighter seal with their respective seats. Both O-rings are preferably made from a rubber or plastic material that will survive the environmental conditions within the drive casing 25, namely the temperature and rigorous fatigue loading requirements. The temperature of the oil around the O-rings is about 60 degrees Celsius. The O-rings are not subjected to high pressure as the oil within the pump 10 is maintained at low pressure, approximately 20 psi to 30 psi.

In this manner the reciprocating pump of the ball screw 31 and attached head piece 23 are used to drive the lubrication system of the pump 10, to lubricate the internals of the pump 10 when in use. In a preferred embodiment the lubricant used is also a coolant, for example oil and as such the drive casing 25 is cooled and simultaneously lubricated off the drive means (ball screw 31) of the linear pump 10.

The oil used is suitable for lubricating both the various bearings within the pump 10 and the ball screw 31 and could be a mineral oil, synthetic oil or the like. Oils with a higher viscosity provide better lubrication over lower viscosity oils. However, oils with a lower viscosity provide better cooling than oils with a higher viscosity. A viscosity of around 100 provides a balance between the lubrication and cooling qualities required; however, this can be adjusted depending on the requirements and working conditions for the pump 10.

The internal lubrication of the pump 10 and elimination of an exterior cooling jacket presents a reduction in component parts of the pump 10 and significant improvements to the internal and external packaging. This in turn provides a weight advantage and compact design with material and mass savings. A further weight saving is realised by eliminating the need for a secondary motor to pump lubricating fluid through a cooling source in the pump 10. It is contemplated that in some embodiments of the invention, an external cooling jacket can be added to the exterior of the pump 10 to provide additional cooling.

Where the piston 51 exits the drive casing 25 and passes through the end cap 17 into the cylinder 55, there is a series of components that axially nest around the piston 51 within a central bore 83 of the end cap 17. These components comprise a guide bush 87, a resilient member and a set of seals. These components are retained between the end cap 17 and the piston 51 and are preferably removable such that maintenance and replacement of the parts can be achieved at regular service intervals.

The inside interface between the chamber 25 and the end cap 17 is sealed by a series of seals 77 that encircle the piston 51 and are fixed within the central bore 83 of the end cap 17. These seals 77 are primarily to prevent lubricant from being drawn into the end cap 17 and into the bore 65 of the cylinder 55. A secondary set of seals 99 is provided within the cylinder 55 shown in FIG. 3 disposed within the cylinder bore 65 adjacent the cylinder liner 67. The second set of seals 99 is a set of high pressure seals. The high pressure seals 99 are configured to prevent high pressure liquid i.e. water being drawn from the cylinder 55 and ultimately the high pressure conduit 59, into the chamber 25 and surrounding chambers 8 and 9. This arrangement is mirrored at the second end of the pump 10, to prevent high pressure water being drawn from a second cylinder 56 and second high pressure conduit 58 into chambers 8 and 9 within the housing of pump 10.

On the outer surface of end cap 17, where the cylinder housing 53 interfaces with the end cap 17, there is a guide bush 87 centrally retained within the bore 83 of end cap 17. The guide bush sits slightly proud of the end cap 17 and thereby provides a mating fixture which corresponds to a circular recess 55a on a mating face of cylinder 55.

The guide bush 87 guides the piston 51 as it travels back and forth towards the cylinder liner 67 within the cylinder 55 and assists in keeping the motion of piston 51 as purely linear as possible. The surface finish and machine tolerances on the components are very high to ensure that alignment and frictional issues are minimised wherever possible.

The guide bush 87 is generally made from a high strength material, at least partially, for example aluminium bronze.

However, it could be formed from any hard wearing bearing material.

The bush 87 can be configured to have a resilient portion therein. As such the bush 87 may be formed from layers of materials having differing resilience. Alternatively, a separate resilient member can be inserted between the bush 87 and first set of seals 77, as illustrated in FIG. 2 as a damper 89. The damper 89 is preferably inserted in proximity to the bushing 87 so that the components can be removed and replaced easily through the central bore 83 of the end cap 17 without the need to dismantle the pump 10 further.

The damper 89 is resilient, in that it is not as strong as the surrounding metal components; however, it is not soft enough to be easily compressible by hand. It can be formed from a hard rubber or plastic material, such as polyurethane.

The damper 89 can provide a sacrificial component within the pump assemblies 48, 49 such that in the event of a catastrophic failure, the residual kinetic energy of moving components within the pump 10, primarily the ball screw nut 30 the rotor 15 and the bearings may be absorbed by the sacrificial damper 89. A potential material for a sacrificial damper is polyethylene. In the event of a pump failure, the energy released from the rotor 15, ball screw nut 30, and A/C bearings, acting like a fly wheel can be sufficient to knock the end caps 16, 17 from the housing 11 and shear the cylinder retaining bolts 54.

By absorbing kinetic energy from moving components within the pump 10, the damper 89 provides protection to other components within the vicinity of the end caps 16, 17 which might otherwise be damaged or destroyed in the event of the pump losing control. Using a damper 89 to absorb the kinetic energy of moving components is intended to provide a replaceable or sacrificial component that minimises damage to the pump 10 and is easily replaceable to get the pump 10 back into service as quickly as possible.

In one embodiment the damper 89 can be made from polyurethane such that the damper 89 is capable of absorbing the kinetic energy imparted by the screw 31 and pistons 51, 52 and fully recovering after compressive loading to resume its original form. Such a material for the damper 89 in this embodiment would be a resilient plastic, for example a high density polyurethane or the like. In this form, the damped 89 does not need to be replaced after a pump failure and is reusable.

The damper 89 is between 10 and 15 mm in depth and is nested within the bore 83 of the end cap 17 of the pump 10, as shown in FIG. 5. In position, the damper 89 is enclosed both axially and radially within the end cap 17, such that the full compressibility of the material can be exploited axially. If the damper 89 is not radially enclosed, the plastic of the damper 89 remains free to expand radially under impact loading, potentially, reducing the energy absorption capacity. In some embodiments the bore 83 of the end cap 17 can be configured to provide a seat upon which the damper 89 seats as an alternative means of constraining the damper 89 under loading conditions. The seat may serve as an axial and radial constraint to the damper 89. It is contemplated that mere radial or mere axial constraint will provide a level of damping and the constraint need not be in both directions.

The servo motor which is used in the preferred embodiment is a brushless DC motor operating on a DC voltage of about 600 volts. This is a motor which is commonly used in machine tools and has traditionally been very controllable to provide the precision which is required in such machine tool applications. The pistons 50, 51 have a stroke of between 100 mm and 200 mm (preferably 125 mm) and reciprocate at approximately 30 to 120 strokes per minute. The movement of a piston 50, 51 in one direction lasts between 0.25 seconds to 1 second, typically 0.8 seconds (each stroke being between 0.5 seconds to 2 seconds in duration). The pump 10 is designed to operate in the most efficient mode with the delivery of water of between 2 L per minute and 8 L per minute.

The encoder 80 enables a pressure feedback closed loop to be set-up, where the encoder 80 is housed at the second end 18 of the rotor 15 and mounted by way of the encoder adaptor 81. The encoder adaptor 81 is supported by the annular bearing 28. The encoder 80 monitors position and/or velocity of the rotor shaft 15.

The encoder 80 is a feature of the pump 10 which provides more accurate control of the rotor 15 by monitoring the pump 10 during use. Alternatively, the pump 10 could be monitored by setting-up the pump 10 to run between a pair of proximity sensors with no encoder 80 feedback.

The encoder 80 sends two feedback signals, namely a velocity feedback signal that is fed to the velocity controller to calculate velocity and a position feedback signal that is fed to the position controller to calculate position. In this manner a computer can be used to control the operation of the motor by monitoring the feedback signals. This computational control provides an extremely positive and accurate control of the linear displacement of the ball screw 31 which means that the linear actuator can be used to replace the hydraulic cylinders conventionally used in applications such as heavy duty presses, injection moulding machines, lifting tables and platforms or high load cutting or polishing machines. The linear actuator is particularly compact and thus is especially useful where there is a need for increased control of speed, position or force and limited space is available.

The pressure feedback loop also enables ready diagnostics of leaks within the system. Through a combination of current, position/velocity and pressure, a leak from the low pressure check valve 73 also known as an inlet check valve can be determined. These are regular maintenance items on ultra-high pressure pumps, and regularly get small fragments of the wearing components between the sealing surfaces allowing the water to go back down the inlet 72 water supply instead of building up pressure.

A transducer may also be included within the pressure feedback loop, ideally placed outside of the pump 10 between the high pressure check valve and the final output of the ultra-highly pressurised water. Through use of a transducer and the encoder 80, it is possible to distinguish between a leaking low pressure check valve 73 and a high pressure line failure so that an appropriate response may be selected to rectify the problem.

A leaking low pressure check valve 73 will need increased velocity to compensate for the leak, whereas a blown high pressure hose or leaking high pressure fitting requires an emergency stop to avoid possible injury to workers and serious damage to the pump 10 itself.

As noted above, a pulsating effect can be caused by the constantly changing direction of the ball screw 31. This effect can lead to uneven wear and early fatigue of downstream machines from the pump 10. Every time the servo motor reverses direction, there is a small delay whilst the ball screw 31 and hence the pistons 50, 51 stop to then reverse direction. This delay can cause as much as a 5,000 psi pressure drop which tends to cause the output pressure of the pump to pulsate.

The pump of the subject application can overcome this problem by teaming the pumps i.e. placing two or more pumps, each with two reciprocating piston and cylinder assemblies, in tandem or in series, and having the pumps running out of phase. When teamed, the two or more pumps are each in communication with one another, to ensure that the two or more pumps remain out of phase with one another. By cycling one drive at twice the speed of the other, while the other pump is reversing, it allows the first pump to build up backpressure to balance the drop in pressure which would be caused through reversal of the ball screw 31 and thus ensure that the output pressure delivered to a downstream machine for example a cutting head is constant, without pulsing.

The servo drive pump 10 described above is far more efficient than an intensifier pump while still offering the desired ability to be able to store and hold pressure while not in use, thus using only minimal power. The further provision of an internal lubrication system that also cools the stator 19, pistons 50, 51 and ball screw 31 and other bearing components 14a 14b and 46, without increasing the external dimensions of the pump 10 provides an efficient ultra-high pressure pumping solution both in terms of external dimensions and mass.

The rotor shaft 15 is designed to run at about 1200 rpm and the piston 50, 51 are about 125 mm in length running in respective bores 65, 66 with a diameter of between 14 mm and 22 mm each. This makes the whole assembly small, light and considerably quieter than an intensifier pump. The servo drive system is also very responsive and pressures can be adjusted within milliseconds with infinite control.

The embodiments described above are suitable for a 15 kW pump; however, where larger pumps are required i.e. a 30 kW pump, additional lubrication and additional cooling is desirable

In another embodiment of the invention a pump 10 is configured to have the lubricating mechanism described herein disposed around each end of the pump 10, as shown in FIGS. 8, 8A and 8B.

FIG. 8A shows the first end of the pump 10, with the drive casing 25 supported by bearings 14a to 14d. A second drive casing 26 is disposed at the second end 18 of the rotor 15. As with drive casing 25, drive casing 26 comprises a series of apertures 101a to allow lubricant to be drawn into the casing 26 from chamber 9. Furthermore, the end cap 16 at the second end of the pump 10 is provided with a plurality of lubricant conduits 97a to draw the lubricant through the pump 10.

A second head piece 22 is removably attached to the second end of the ball screw 31 to receive and secure the second piston 50. The configuration of components at the second end of the pump 10, are as described above in relation to the first end of the pump 10. A duplicate set of high pressure seals 77, guide bush 88 and resilient damper 90 are housed within the end cap 16 to provide sealing, guidance and an energy absorbing member at the second end of the pump 10. However, the bearings 14a-14d and the encoder 80 are not duplicated at the two ends of the pump 10 in the embodiment shown in FIGS. 8 to 8B.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A linear actuator comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism, the drive mechanism having opposed ends, one end coupled to a piston arranged within a cylinder to define a pumping chamber between the piston and the cylinder, wherein alternating rotation of the rotor shaft causes reciprocal linear displacement of the piston within the pumping chamber, and the linear displacement of the drive mechanism operates a lubrication system within the linear actuator.

2. The linear actuator according to claim 1, wherein the rotor shaft is a hollow rotor shaft

3. The linear actuator according to claim 2, wherein an interior of the hollow rotor shaft is co-axially coupled to the drive mechanism.

4. The linear actuator according to claim 1, wherein the linear motion of the piston within the pumping chamber constitutes a pump to thereby drive the lubrication system within the linear actuator.

5. The linear actuator according to claim 1, further comprising a check valve operably associated with an aperture within the pumping chamber, wherein the check valve moves between an open and a closed position in response to pressure changes within the pumping chamber.

6. The linear actuator according to claim 1, wherein the lubrication system comprises a lubricant reservoir in fluid connection with at least one lubricant conduit configured to draw lubricant into the pumping chamber, and a pair of check valves disposed at an inlet and an outlet of the at least one lubricant conduit wherein the check valves are configured to control the flow of lubricant through the at least one lubricant conduit.

7. The linear actuator according to claim 1, wherein the drive mechanism comprises a linearly fixed nut that is in direct engagement with the rotor shaft, the nut threadedly engaging a screw whereby axial rotation of the rotor shaft, and therefore the nut, imparts linear motion to the screw.

8. The linear actuator according to claim 7, wherein a first end of the screw is adapted to receive a first piston and a second end of the screw is adapted to receive a second piston, such that the linear motion of the screw is translated to the pistons.

9. The linear actuator according to claim 8, wherein the first end of the screw is configured to prevent rotational movement of the screw within the pumping chamber.

10. The linear actuator according to claim 8, wherein a head piece is detachably secured to the first end of the screw to receive the first piston.

11. The linear actuator according to claim 10, wherein the head piece (Original) to prevent rotation of the screw.

12. The linear actuator according to claim 11, wherein the co-operating structure of the pumping chamber is an elongate slot.

13. The linear actuator according to claim 8, wherein a second head piece is detachably secured to the second end of the screw to receive the second piston.

14. (canceled)

15. A linear actuator comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism, the drive mechanism being linearly constrained within the linear actuator, and the drive mechanism having opposed ends, one end coupled to a piston arranged within a cylinder to define a pumping chamber between the piston and the cylinder, wherein alternating rotation of the rotor shaft causes reciprocal linear displacement of the piston within the pumping chamber.

16. The linear actuator according to claim 15, wherein the drive mechanism is constrained to prevent rotation.

17. The linear actuator according to claim 15, wherein the drive mechanism is coupled to a linear bearing.

18. The linear actuator according to claim 17, wherein the linear bearing comprises a stationary base and a cooperating carriage wherein the carriage is linearly translatable along the base.

19. An ultra-high pressure pump comprising a motor adapted to axially rotate a rotor shaft in alternating directions, the motor having a stator positioned co-axially around the rotor shaft with the rotor shaft being co-axially coupled to a drive mechanism to convert axial rotation of the rotor shaft into reciprocal displacement of the drive mechanism, the drive mechanism having opposed ends, one end coupled to a piston arranged within a cylinder to define a pumping chamber between the piston and the cylinder, the pumping chamber being in fluid connection with a compression chamber, wherein alternating rotation of the rotor shaft causes reciprocal linear displacement of the piston within the pumping chamber to pressurise fluid in the compression chamber, and said linear displacement of the drive mechanism operates a lubrication system within the pump.

20. The ultra-high pressure pump according to claim 19, wherein a lubricant of the lubrication system is a coolant.

21. The linear actuator according to claim 1, wherein a lubricant of the lubrication system is a coolant.
